(19) United States
(12) Patent Application Publication
(10) Pub. No.: US 2013/0315205 A1
(43) Pub. Date: Nov. 28, 2013

(54) WIRELESS COMMUNICATION STATION AND TRANSMISSION INTERFACE SWITCHING METHOD THEREOF

(71) Applicant: Institute For Information Industry, Taipei (TW)

(72) Inventors: Shu-Tsz LIU, Taipei City (TW); Kanchei Loa, Taipei City (TW)

(73) Assignee: Institute For Information Industry, Taipei (TW)

(21) Appl. No.: 13/901,967

(22) Filed: May 24, 2013

Related U.S. Application Data
(60) Provisional application No. 61/651,475, filed on May 24, 2012.

(51) Int. Cl. H04W 40/36

(52) U.S. Cl. CPC H04W 40/36
USPC 370/331; 370/328

(57) ABSTRACT

A wireless communication station and a transmission interface switching method thereof are provided. A network system includes the wireless communication station and a base station. The wireless communication station and the base station have a first connection therebetween. The wireless communication station disconnects the first connection, establishes a second connection, and establishes a target transmission interface with the base station via the second connection. Alternatively, the wireless communication station does not disconnect the first connection, and establishes the target transmission interface via the first connection. The target transmission interface is formed between the wireless communication station and a base station module, a serving gateway, a packet data network gateway, and a relay gateway of the base station.

### PRIORITY

This application claims the benefit of U.S. Provisional Application Ser. No. 61/651,475 filed on May 24, 2012, which is hereby incorporated by reference in its entirety.

### FIELD

The present invention relates to a wireless communication station and a transmission interface switching method thereof; and more particularly, the wireless communication station and the transmission interface switching method thereof according to the present invention are used to switch a transmission interface to provide a desirable transmission path.

### BACKGROUND

Nowadays, wireless communication protocol frameworks such as the 3^{rd} Generation Partnership Project (3GPP) standard and the Long Term Evolution (LTE) standard have been widely applied in various different circumstances. However, wireless communication stations adopting the 3GPP and LTE frameworks (e.g., user equipment (UE) stations or relay nodes (RNs)) may need to switch between base stations in some cases.

Now, several cases where a wireless communication station needs to switch between base stations will be exemplified. For example, the wireless communication station needs to switch between base stations when the quality of service (QoS) between a base station and the wireless communication station degrades or fails to reach a preset level, when the reference signal receiving power (RSRP) between the base station and the wireless communication station degrades or fails to reach a preset level, when the signal to interference plus noise ratio (SINR) between the base station and the wireless communication station increases, or when the wireless communication station moves into communication coverage of another base station. In such cases, the wireless communication station will need to be handed over to another base station that can serve the wireless communication station better so as to continuously obtain wireless communication services.

In the prior art, after a wireless communication station hands over from an original base station (i.e., a base station to which the wireless communication station originally connects) to any other base station, a transmission interface of the wireless communication station (e.g., an S1 interface or an S5/S8 interface of the LTE standard) still has to transmit data via a relay gateway and a packet data network gateway (P-Gateway) of the original base station, or even also has to transmit data via a serving gateway (S-GW) of the original base station. Consequently, if the wireless communication station moves further away from the original base station as it hands over from one base station to another successively, the distance between the base station to which it currently connects and the original base station will become increasingly longer. Thus, the data transmission path will become longer to result in a transmission delay. Or, the data transmission quality may also degrade due to the degraded communication quality between the wireless communication station and the original base station.

Accordingly, an urgent need exists in the art to provide a solution allowing the wireless communication station to transmit data in an efficient way or in a transmission path that delivers a desirable communication quality after a handover procedure.

### SUMMARY

To solve the aforesaid problem of transmission delay, the present invention, in certain embodiments, provides a wireless communication station and a transmission interface switching method thereof

A wireless communication station according to certain embodiments of the present invention is for use in a network system. The network system comprises the wireless communication station and a base station. The wireless communication station comprises a first user equipment (UE) module, a second UE module, and a first base station module. The first UE module has a first wireless connection with the base station. The second UE module establishes a second wireless connection with the base station. The first base station module is electrically connected with the second UE module and is configured to establish a target transmission interface with the base station via the second wireless connection so that the target transmission interface is formed between the first base station module, the second UE module, and a base station module, a serving gateway, a packet data network gateway and a relay gateway of the base station. The first UE module is further configured to disconnect the first wireless connection.

A wireless communication station according to certain embodiments of the present invention is for use in a network system. The network system comprises the wireless communication station and a base station. The wireless communication station comprises a first UE module, a base station module and a second UE module. The first UE module has a first wireless connection with the base station. The base station module is electrically connected with the first UE module. The second UE module is electrically connected with the base station module and is configured to establish a second wireless connection with the base station. The base station module is further configured to establish a first original transmission interface with the base station via the first wireless connection and perform a transmission interface adjustment procedure on the first original transmission interface. The base station module is further configured to establish a target transmission interface with the base station via the second wireless connection so that the target transmission interface is formed between the base station module, the second UE module, and a base station module, a serving gateway, a packet data network gateway and a relay gateway of the base station. The first UE module is further configured to disconnect the first wireless connection.

A wireless communication station according to certain embodiments of the present invention is for use in a network system. The network system comprises the wireless communication station and a base station. The wireless communication station comprises a UE module and a base station module. The UE module has a wireless connection with the base station. The base station module is electrically connected with the UE module. Wherein, a first original transmission interface between the base station module and the base station that is established via the wireless connection is adjusted into a target transmission interface so that the target transmission interface is formed between the base station module, the UE module, and a base station module, a serving gateway, a packet data network gateway and a relay gateway of the base station.

A transmission interface switching method according to certain embodiments of the present invention is for use in a wireless communication station of a network system. The network system comprises the wireless communication station and a base station. The wireless communication station comprises a first UE module, a second UE module and a first base station module. The first base station module is electrically connected with the second UE module, and the first UE module has a first wireless connection with the base station.

The transmission interface switching method, in certain embodiments, comprises the steps of: (a) enabling the second UE module to establish a second wireless connection with the base station; (b) enabling the first base station module to establish a target transmission interface with the base station via the second wireless connection so that the target transmission interface is formed between the first base station module, the second UE module, and a base station module, a serving gateway, a packet data network gateway and a relay gateway of the base station; and (c) enabling the first UE module to disconnect the first wireless connection.

A transmission interface switching method according to certain embodiments of the present invention is for use in a wireless communication station of a network system. The network system comprises the wireless communication station and a base station. The wireless communication station comprises a first UE module, a second UE module and a base station module. Both the first UE module and the second UE module is electrically connected with the base station module, and the first UE module has a first wireless connection with the base station.

The transmission interface switching method, according to certain embodiments, comprises the steps of: (a) enabling the second UE module to establish a second wireless connection with the base station; (b) enabling the base station module to establish a first original transmission interface with the base station via the first wireless connection; (c) enabling the base station module to perform a transmission interface adjustment procedure on the first original transmission interface; (d) enabling the base station module to establish a target transmission interface with the base station via the second wireless connection so that the target transmission interface is formed between the base station module, the second UE module, and a base station module, a serving gateway, a packet data network gateway and a relay gateway of the base station; and (e) enabling the first UE module to disconnect the first wireless connection.

A transmission interface switching method according to certain embodiments of the present invention is for use in a wireless communication station of a network system. The network system comprises the wireless communication station and a base station. The wireless communication station comprises a UE module and a base station module. The UE module is electrically connected with the base station module, and the UE module has a wireless connection with the base station.

The transmission interface switching method, in certain embodiments, comprises the step of: (a) adjusting a first original transmission interface between the base station module and the base station that is established via the wireless connection into a target transmission interface via the wireless connection so that the target transmission interface is formed between the base station module, the UE module, and a base station module, a serving gateway, a packet data network gateway and a relay gateway of the base station.

In certain embodiments of the present invention, after performing a handover procedure on the wireless connection, the wireless communication station optionally switches or adjusts the transmission interface so that the packet data network gateway and the relay gateway that are originally anchored to the original base station (even the serving gateway that is originally anchored to the original base station) are anchored to the target base station instead. With the mechanism of the present invention, the wireless communication station can exchange data with the target base station and an evolved packet core (EPC) via the target transmission interface formed between the wireless communication station and the target base station without having to still exchange data with the original base station. With the wireless communication station and the transmission interface switching method provided in the present invention, problems such as the transmission delay or the transmission quality degradation caused by a too long transmission path can be avoided.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a timing flowchart diagram depicting a wireless connection setup procedure P1;

FIG. 1B is a timing flowchart diagram depicting a transmission interface setup procedure P2;

FIG. 1C is a timing flowchart diagram depicting a transmission interface adjustment procedure P3;

FIG. 1D is a block diagram depicting a network system 1 according to a first embodiment of the present invention;

FIG. 2 is a block diagram depicting a network system 2 according to a second embodiment and a fourth embodiment of the present invention;

FIG. 3 is a block diagram depicting a network system 3 according to a third embodiment of the present invention;

FIG. 4 is a block diagram depicting a network system 4 according to a fifth embodiment of the present invention;

FIG. 5 is a flowchart diagram depicting a sixth embodiment of the present invention;

FIG. 6 is a flowchart diagram depicting a seventh embodiment of the present invention;

FIG. 7 is a flowchart diagram depicting an eighth embodiment of the present invention;

FIG. 8 is a flowchart diagram depicting a ninth embodiment of the present invention; and

FIG. 9 is a flowchart diagram depicting a tenth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these example embodiments. Therefore, description of these embodiments is only for purpose of illustration but not to limit the present invention. It should be appreciated that, in the following embodiments and the attached drawings, elements unrelated to the present invention are omitted from depiction.

The present invention relates to a wireless communication station for use in a network system. The network system may conform to the 3GPP standard, the LTE standard or some other wireless communication standard known by those of ordinary skill in the art. The wireless communication station of the present invention may be a user equipment (UE), a stationary relay station or a mobile relay station.

The wireless communication station originally has a first wireless connection with a source base station (i.e., a base station to which the wireless communication station currently connects). After the wireless communication station performs a handover procedure with the source base station and a target base station (i.e., a base station to which the wireless communication station connects after the handover procedure), the first wireless connection is changed to be between the wireless communication station and the target base station instead. The wireless communication station disconnects the first wireless connection, establishes a second wireless connection with the target base station, and establishes a target transmission interface with the target base station via the second connection. Alternatively, the wireless communication station may not disconnect the first wireless connection, but establish a target transmission interface directly via the first wireless connection. With the aforesaid mechanism, the target transmission interface is formed between the wireless communication station and a base station module, a serving gateway, a packet data network gateway and a relay gateway of the target base station.

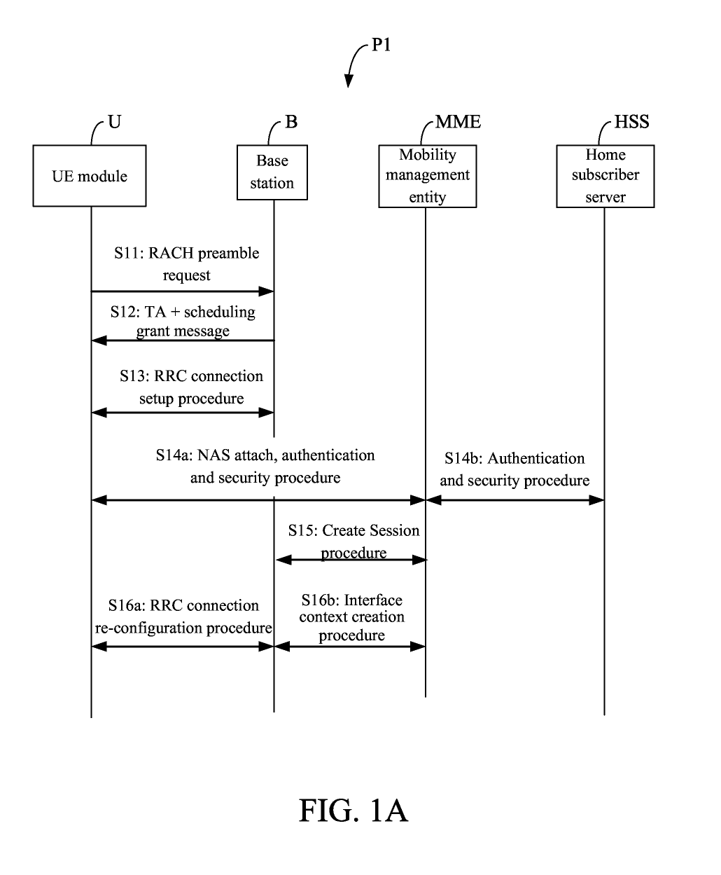

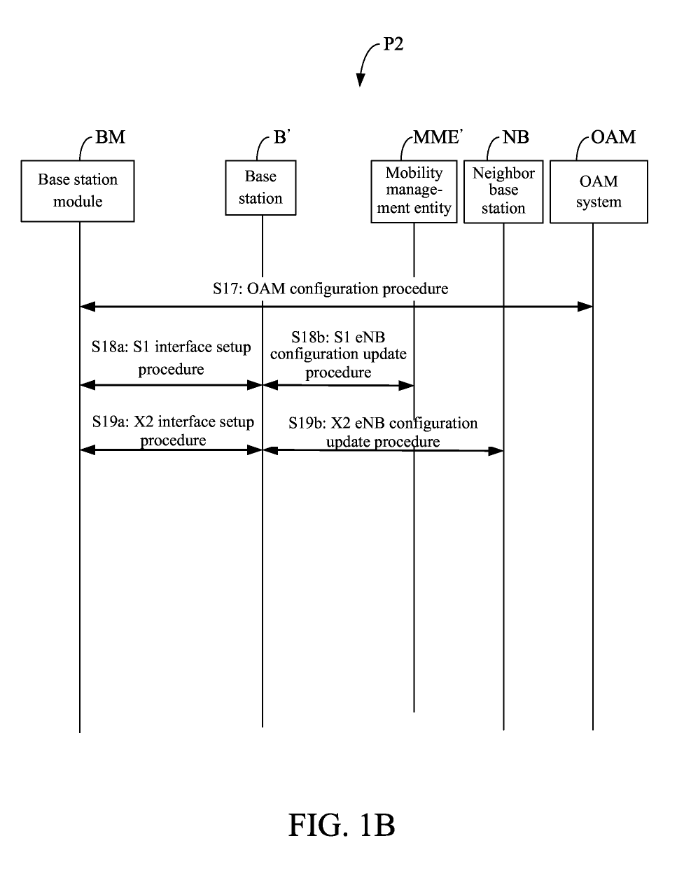

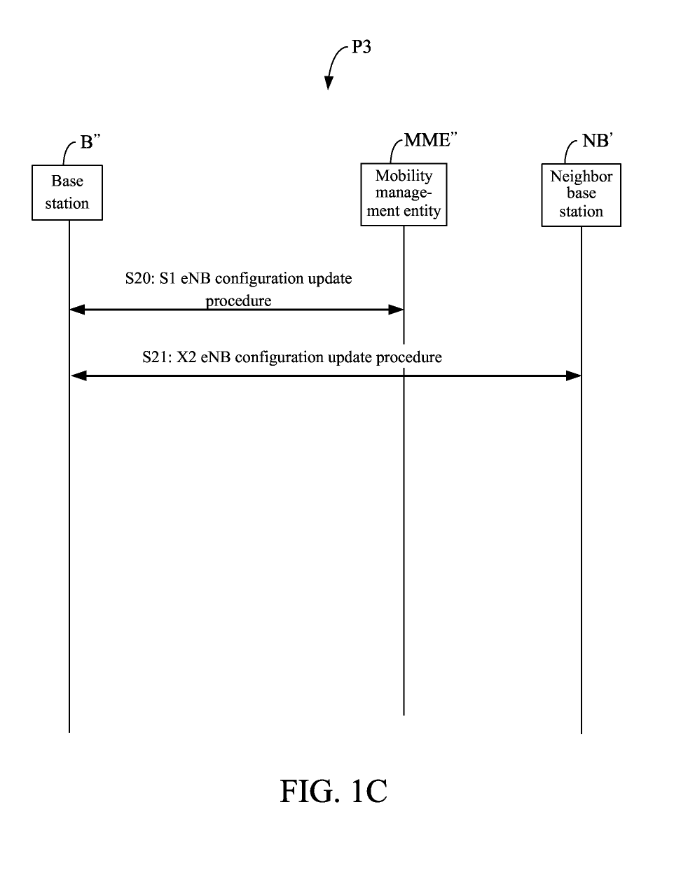

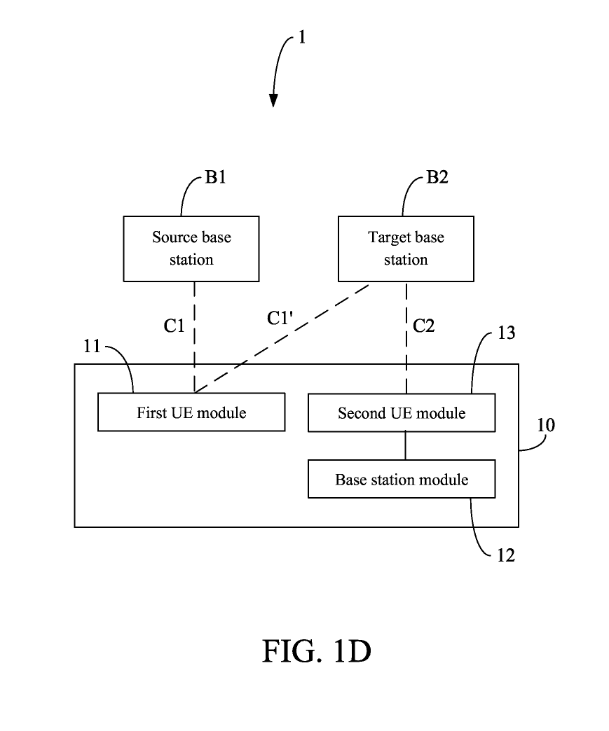

Before embodiments of the present invention are detailed, the following three procedures to be used in the present invention will be introduced firstly: a wireless connection setup procedure P1, a transmission interface setup procedure P2 and a transmission interface adjustment procedure P3. Timing flowchart diagrams of the three procedures are respectively depicted in FIGS. 1A, 1B and 1C.

The wireless connection setup procedure P1 is performed by a UE module U, a base station B, a mobility management entity (MME) MME and a home subscriber server (HSS) HSS.

It should be appreciated that, the mobility management entity MME is a relay node mobility management entity (RN-MME) or a user equipment mobility management entity (UE-MME) depending on the nature of the wireless communication station to which the UE module U belongs. Further speaking, if the wireless communication station to which the UE module U belongs is a relay station, then the mobility management entity MME here is a RN-MME; and if the wireless communication station to which the UE module U belongs is a UE, then the mobility management entity MME in the wireless connection setup procedure P1 is a UE-MME.

The following steps are executed in the wireless connection setup procedure P1. The UE module U transmits a random access channel (RACH) preamble request S11 to the base station B. If the base station B permits to establish a wireless connection with the UE module U, the base station B responds a TA + scheduling grant message S12 to the UE module U. Then, a radio resource control (RRC) connection setup procedure S13 which carries a non-access stratum attach (NAS attach) signal is performed between the UE module U and the base station B.

After the RRC connection setup procedure S13 is performed, an NAS attach, authentication and security procedure S14a is performed between the UE module U and the mobility management entity MME, and an authentication and security procedure S14b is performed by the mobility management entity MME and the home subscriber server HSS. Subsequently, a Create Session procedure S15 is performed between the base station B and the mobility management entity MME. The Create Session procedure S15 is a GPRS Tunneling Protocol for the control plane (GTP-C) Create Session procedure.

After the Create Session procedure S15 is performed, an RRC connection re-configuration procedure S16a is performed between the UE module U and the base station B, and an interface context creation procedure S16b is performed between the base station B and the mobility management entity MME. The interface context creation procedure S16b is performed to create an S1 context and carries an NAS attach receiving signal.

The transmission interface setup procedure P2 is performed by a base station module BM, a base station B′, a mobility management entity MME′ and an operation, administration and maintenance (OAM) system OAM.

It should be appreciated that, the mobility management entity MME′ is an RN-MME or a UE-MME. People skilled in the art can know which kind of MME the mobility management entity MME′ will be in different circumstances, so this will not be further described herein.

The following steps are executed in the transmission interface setup procedure P2. An operation, administration and maintenance configuration procedure S17 is performed by the operation, administration and maintenance system OAM and the base station module BM. Afterwards, an S1 interface setup procedure S18a is performed between the base station module BM and the base station B′, and an S1 eNB configuration update procedure S18b is performed between the base station B′ and the mobility management entity MME′.

Then, an X2 interface setup procedure S19a is performed between the base station module BM and the base station B′, and an X2 eNB configuration update procedure S19b is performed between the base station B′ and a neighbor base station.

The transmission interface adjustment procedure P3 is performed by a base station B″, a mobility management entity MME″ and a neighbor base station NB′.

The following steps are executed by the transmission interface adjustment procedure P3. An S1 eNB configuration update procedure S20 is performed between the base station B″ and the mobility management entity MME″. Then, an X2 eNB configuration update procedure S21 is performed between the base station B″ and the neighbor base station NB′.

A first embodiment of the present invention will be described with reference to FIGS. 1A, 1B and 1D. FIG. 1D is a block diagram depicting a network system 1. The network system 1 comprises a wireless communication station 10, a source base station B1 and a target base station B2. The wireless communication station 10 comprises a first UE module 11, a second UE module 13 and a base station module 12 electrically connected with the second UE module 13.

In this embodiment, the wireless communication station 10 needs to perform a handover procedure in some cases. For example, the wireless communication station 10 needs to perform the handover procedure when the quality of service (QoS) of the source base station B1 that originally serves the wireless communication station 10 degrades or fails to reach a preset level, when the reference signal receiving power (RSRP) between the source base station B1 and the wireless communication station 10 decreases, when the signal to interference plus noise ratio (SINR) between the source base station B1 and the wireless communication station 10 increases, and/or when the wireless communication station 10 moves into communication coverage of the target base station B2. When the wireless communication station 10 needs to be handed over, a handover procedure is performed between the first UE module 11, the source base station B1 and the target base station B2.

After the handover procedure, the first wireless connection C1 that is originally between the wireless communication station 10 and the source base station B1 is changed to be between the wireless communication station 10 and the target base station B2, i.e., becomes a first wireless connection C1′. Next, if the wireless communication station 10 (e.g., the base station module 12) or the target base station B2 determines that the QoS of the base station that originally serves the wireless communication station 10 degrades or fails to reach a preset level, the RSRP between the base station and the wireless communication station 10 decreases, or the SINR between the base station and the wireless communication station 10 increases, the measurement data reported by the wireless communication station 10 to the target base station B2 indicates, then the transmission interface between the wireless communication station 10 and the source base station B1 and the target base station B2 is switched. If the wireless communication station 10 is a mobile station, the transmission interface between the wireless communication station 10 and the source base station B1 and the target base station B2 is switched after each handover procedure, or after the mobile station passes through a fixed number of base stations, or when the mobile station stops in some specific regions.

When the wireless communication station 10 (e.g., the base station module 12) or the target base station B2 determines that the path of the transmission interface needs to be switched to shorten the transmission path, the switching operation is performed as follows. Firstly, the second UE module 13 establishes a second wireless connection C2 with the target base station B2, for example, through the wireless connection setup procedure P1. Here, the UE module U and the base station B described in the wireless connection setup procedure P1 are respectively the second UE module 13 and the target base station B2 in this embodiment.

Subsequently, the base station module 12 establishes a target transmission interface (not shown) with the target base station B2 via the second wireless connection C2, for example, through the transmission interface setup procedure P2. Thereby, the target transmission interface is formed between the base station module 12, the second UE module 13, and a base station module, a serving gateway, a packet data network gateway and a relay gateway of the target base station B2 (not shown). Here, the base station module BM and the base station B′ described in the transmission interface setup procedure P2 are respectively the base station module 12 and the target base station B2 in this embodiment. Afterwards, the first UE module 11 disconnects the first wireless connection C1′ with the target base station B2. The aforesaid target transmission interface is an S1/X2 interface.

It should be appreciated that, the path between the serving gateway, the packet data network gateway and the relay gateway in the target transmission interface or even the path between the base station module, the serving gateway, the packet data network gateway and the relay gateway in the target transmission interface can be pre-established by a mobility management entity. When the base station module 12 is to establish the target transmission interface with the target base station B2, the base station module 12 only needs to further establish the path of other portions in the target transmission interface. How the path is pre-established can be appreciated by people skilled in the art and, thus, will not be further described herein.

It should be appreciated that, in other implementations, it is not required to perform the handover procedure firstly before the wireless communication station 10 (e.g., the base station module 12) or the target base station B2 determines that the path of the transmission interface needs to be switched. In other words, the present invention can switch the path of the transmission interface without the need of performing a handover procedure firstly.

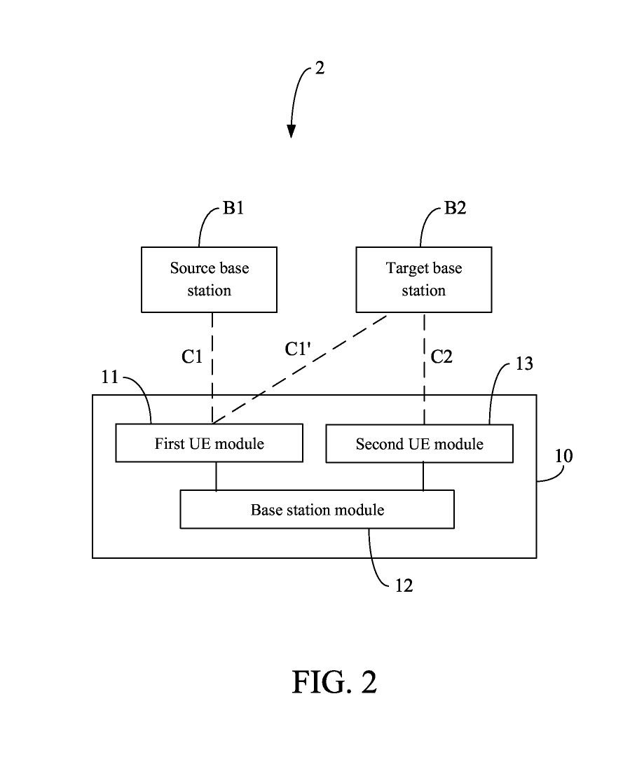

A second embodiment of the present invention will be described with reference to FIGS. 2, 1A, 1B and 1C. FIG. 2 is a block diagram depicting a network system 2. Elements comprised in the network system 2 of the second embodiment are the same as those comprised in the network system 1 of the first embodiment and perform the same operations. Hereinbelow, only differences of the second embodiment from the first embodiment will be described.

In this embodiment, the base station module 12 of the wireless communication station 10 is further electrically connected with the first UE module 11. In other words, the base station module 12 is electrically connected with both the first UE module 11 and the second UE module 13.

In this embodiment, before the handover procedure is performed on the first wireless connection C1, the base station module 12 has an original transmission interface (not shown) with the source base station B1 via the first wireless connection C1. Usually, a serving gateway, a packet data network gateway and a relay gateway are anchored to an original base station (not shown). The original transmission interface has three kinds of implementations as follows.

One implementation is a case where the original base station is just the source base station B1. In this context, the original transmission interface is between the base station module 12, the first UE module 11, and a serving gateway, a packet data network gateway and a relay gateway of a base station module of the source base station B1. In such a case, the original transmission interface is an S1 interface.

The other two implementations are cases where the original base station and the source base station B1 are different base stations. In this context, the original transmission interface is between the base station module 12, the first UE module 11, a base station module of the source base station B1, and a serving gateway, a packet data network gateway and a relay gateway of the original base station. In such a case, the original transmission interface is an S1 interface. Or, the original transmission interface is between the base station module 12, the first UE module 11, a base station module and a serving gateway of the source base station B1, and a packet data network gateway and a relay gateway of the original base station. In such a case, the original transmission interface is defined to have an S5/S8 interface between the serving gateway of the source base station B1 and the packet data network gateway of the original base station, and have an S1 interface between the base station module 12, the first UE module 11, and the base station module and the serving gateway of the source base station B1.

Subsequently, when the handover procedure is performed on the first wireless connection C1, the base station module 12 detaches the original transmission interface with the source base station B1, for example, through the transmission interface adjustment procedure P3. However, in other implementations, the base station module 12 may detach the original transmission interface with the source base station B1 in other period rather than the period of performing the handover procedure. It should be appreciated that, the base station B″ described in the transmission interface adjustment procedure P3 is just the source base station B1 in this embodiment; i.e., the procedures S20 and S21 are performed to notify the management entity MME″ and the neighbor base station NB that the original transmission interface has been detached.

Furthermore, the source base station B1 and the target base station B2 can communicate with each other to exchange via an X2 message therebetween information related to the first wireless connection C1. However, in other implementations, the source base station B1 and the target base station B2 can also exchange therebetween the information related to the first wireless connection in other ways. Then, the second UE module 13 establishes the second connection C2, for example, through the wireless connection setup procedure P1. Subsequently, the base station module 12 establishes a target transmission interface with the target base station B2 via the second UE module 13, for example, through the transmission interface setup procedure P2. Here, the base station module BM and the base station B′ described in the transmission interface setup procedure P2 are respectively the base station module 12 and the target base station B2 in this embodiment. How the second wireless connection C2 and the target transmission interface are established has been described in the first embodiment, so no further description will be made herein. The aforesaid transmission interface is an S1/X2 interface.

Furthermore, in this embodiment, the base station module 12 establishes the target transmission interface C2 after the handover procedure is performed by the first UE module 11.

In addition to the aforesaid operations, the second embodiment can also execute all the operations set forth in the first embodiment. How the second embodiment executes these operations will be readily appreciated by those of ordinary skill in the art based on the explanation of the first embodiment and, thus, will not be further described herein.

It should be appreciated that, in this embodiment, it is not required to perform the handover procedure firstly before the wireless communication station 10 (e.g., the base station module 12) or the target base station B2 determines that the path of the transmission interface needs to be switched. In other words, the present invention can switch the path of the transmission interface without the need of performing a handover procedure firstly.

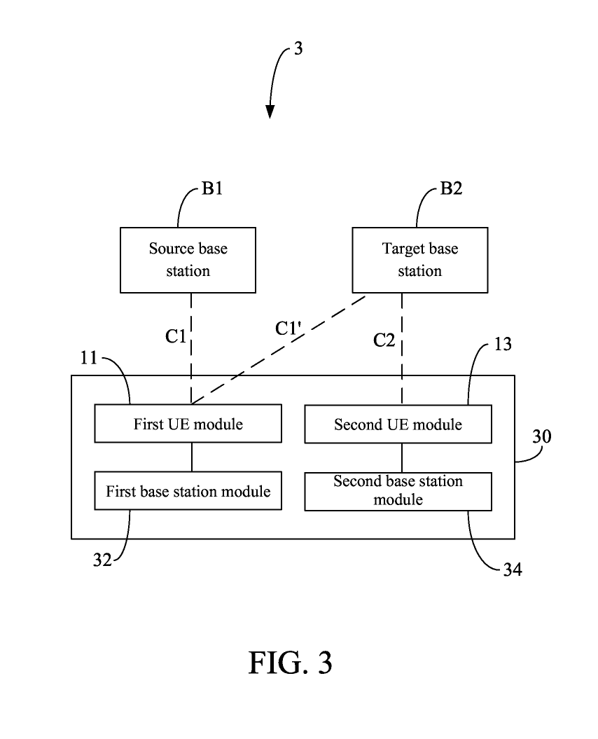

A third embodiment of the present invention will be described with reference to FIGS. 3, 1A, 1B and 1C. FIG. 3 is a block diagram depicting a network system 3. Elements comprised in the network system 3 of the third embodiment are substantially the same as those comprised in the network system 1 of the first embodiment and perform the same operations. Hereinbelow, only differences of the third embodiment from the first embodiment will be described.

In this embodiment, the network system 3 comprises a wireless communication station 30. The wireless communication station 30 corresponds to the wireless communication station 10 of the first embodiment but differs in that: the wireless communication station 30 of this embodiment comprises a first base station module 32 and a second base station module 34, and the second base station module 34 corresponds to the base station module 12 of the first embodiment.

Firstly, the wireless communication station 30 needs to perform a handover procedure in some cases. For example, the wireless communication station 30 needs to perform the handover procedure when the QoS of the source base station B1 that originally serves the wireless communication station 30 degrades or fails to reach a preset level, when the RSRP between the source base station B1 and the wireless communication station 30 decreases, or when the SINR between the source base station B1 and the wireless communication station 30 increases, and/or when the wireless communication station 30 moves into communication coverage of the target base station B2. When the wireless communication station 30 needs to be handed over, a handover procedure is performed between the first UE module 11, the source base station B1 and the target base station B2.

Before the handover procedure is performed on the first wireless connection C1, the first base station module 32 has a first original transmission interface (not shown) with the source base station B1 via the first wireless connection C1. The first original transmission interface has three kinds of implementations. The implementations of the first original transmission interface are the same as those described in the second embodiment except that the base station module 12 of the second embodiment corresponds to the first base station module 32 of this embodiment, so no further description will be made herein.

After the handover procedure, a first wireless connection C1 that is originally between the wireless communication station 30 and the source base station B1 is changed to be between the wireless communication station 30 and the target base station B2, i.e., becomes a first wireless connection C1′. Subsequently, the first base station module 32 establishes a second original transmission interface (not shown) with the target base station B2 via the first wireless connection C1′ that has been handed over; for example, this is accomplished through the transmission interface setup procedure P2. Here, the base station module BM and the base station B′ described in the transmission interface setup procedure P2 are respectively the first base station module 32 and the target base station B2 in this embodiment. The second original transmission interface has four kinds of implementations, which will be described as follows.

Two of the implementations of the second original transmission interface are cases where the original base station is the source base station B1. In this context, the second original transmission interface is between the first base station module 32, the first UE module 11, a base station module of the target base station B2, and a serving gateway, a packet data network gateway and a relay gateway of the source base station B1. In such a case, the second original transmission interface is an S1 interface. Alternatively, the second original transmission interface is between the first base station module 32, the first UE module 11, a base station module and a serving gateway of the target base station B2, and a packet data network gateway and a relay gateway of the source base station B1. In such a case, the second original transmission interface is defined to have an S5/S8 interface between the serving gateway of the target base station B2 and the packet data network gateway of the source base station B1, and have an S1 interface between the first base station module 32, the first UE module 11, and the base station module and the serving gateway of the target base station B2.

The other two implementations are cases where the original base station and the source base station B1 are different base stations. In this context, the second original transmission interface is between the first base station module 32, the first UE module 11, a base station module of the target base station B2, and a serving gateway, a packet data network gateway and a relay gateway of the original base station. In such a case, the second original transmission interface is an S1 interface. Alternatively, the second original transmission interface is between the first base station module 32, the first UE module 11, a base station module and a serving gateway of the target base station B2, and a packet data network gateway and a relay gateway of the original base station. In such a case, the second original transmission interface is defined to have an S5/S8 interface between the serving gateway of the target base station B2 and the packet data network gateway of the original base station, and have an S1 interface between the first base station module 32, the first UE module 11, and the base station module and the serving gateway of the target base station B2.

Next, if the wireless communication station 30 (e.g., the first base station module 32 or the second base station module 34) or the target base station B2 determines that the QoS of the base station that originally serves the wireless communication station 30 degrades or fails to reach a preset level, the RSRP between the base station and the wireless communication station 30 decreases, or the SINR between the base station and the wireless communication station 30 increases, the measurement data reported by the wireless communication station 30 to the target base station B2 indicates, then the transmission interface between the wireless communication station 30 and the source base station B1 and the target base station B2 is switched. If the wireless communication station 30 is a mobile station, the transmission interface between the wireless communication station 30 and the source base station B1 and the target base station B2 is switched after each handover procedure, or after the mobile station passes through a fixed number of base stations, or when the mobile station stops in some specific regions.

When the wireless communication station 30 (e.g., the first base station module 32 or the second base station module 34) or the target base station B2 determines that the path of the transmission interface needs to be switched to shorten the transmission path, the switching operation is performed as follows. When the handover procedure is performed on the first wireless connection C1, the first base station module 32 can detach the first original transmission interface with the source base station B1, for example, through the transmission interface adjustment procedure P3. However, in other implementations, the first base station module 32 may detach the first original transmission interface with the source base station B1 in other period rather than the period of performing the handover procedure. It should be appreciated that the base station B″ described in the transmission interface adjustment procedure P3 is the source base station B1 in this embodiment; i.e., the procedures S20 and S21 are performed to notify the management entity MME″ and the neighbor base station NB that the first original transmission interface has been detached.

Furthermore, the source base station B1 and the target base station B2 can communicate with each other to exchange via an X2 message therebetween information related to the first wireless connection C1. However, in other implementations, the source base station B1 and the target base station B2 can also exchange therebetween the information related to the first wireless connection in other ways.

When the wireless communication station 30 or the target base station B2 determines that the path of the transmission interface needs to be switched, the switching operation is performed as follows. The second UE module 13 establishes the second wireless connection C2, for example, through the wireless connection setup procedure P1. Here, the UE module U and the base station B described in the wireless connection setup procedure P1 are respectively the second UE module 13 and the target base station B2 in this embodiment.

Subsequently, the second base station module 34 establishes a target transmission interface (not shown) with the target base station B2 via the second UE module 13, for example, through the transmission interface setup procedure P2. Thereby, the target transmission interface is formed between the second base station module 34, the second UE module 13, and a base station module, a serving gateway, a packet data network gateway and a relay gateway of the target base station B2 (not shown). Here, the base station module BM and the base station B′ described in the transmission interface setup procedure P2 are respectively the second base station module 34 and the target base station B2 in this embodiment. How the second wireless connection C2 and the target transmission interface are established has been described in the first embodiment and, thus, will not be further described herein. The aforesaid target transmission interface is an S1/X2 interface.

After the target transmission interface is established, the first base station module 32 may detach the second original transmission interface with the target base station B2, for example, through the transmission interface adjustment procedure P3. However, in other implementations, the first base station module 32 may detach the second original transmission interface with the target base station B2 not after the target transmission interface is established. It should be appreciated that the base station B″ described in the transmission interface adjustment procedure P3 is just the target base station B2 in this embodiment; i.e., the procedures S20 and S21 are performed to notify the management entity MME″ and the neighbor base station NB that the second original transmission interface has been detached.

It should be appreciated that the path between the serving gateway, the packet data network gateway and the relay gateway in the target transmission interface or even the path between the base station module, the serving gateway, the packet data network gateway and the relay gateway in the target transmission interface can be pre-established by a mobility management entity. When the second base station module 34 is to establish the target transmission interface with the target base station B2, the base station module 12 only needs to further establish the path of other portions in the target transmission interface. How the path is pre-established can be appreciated by people skilled in the art and, thus, will not be further described.

While the target transmission interface is being established, the first base station module 32 and the second base station module 34 exchange therebetween interface information related to the second original transmission interface and the target transmission interface. The interface information may be exchanged via a current or new X2 message or an internal communication protocol message between the first base station module 32 and the second base station module 34.

After the information exchange is completed, the first base station module 32 or the second base station module 34 transmits a notification message to the target base station B2 so that the target base station B2 updates the interface information with the mobility management entity MME″ and the neighbor base station NB, for example, through the transmission interface adjustment procedure P3. The base station B″ described in the transmission interface adjustment procedure P3 is the target base station B2 in this embodiment. Then, the first UE module 11 disconnects the first wireless connection C1′ with the target base station B2.

In addition to the aforesaid operations, the third embodiment can also execute all the operations set forth in the first embodiment. How the third embodiment executes these operations will be readily appreciated by those of ordinary skill in the art based on the explanation of the first embodiment and, thus, will not be further described herein.

It should be appreciated that, in this embodiment, it is not required to perform the handover procedure firstly before the wireless communication station 30 (e.g., the first base station module 32 or the second base station module 34) or the target base station B2 determines that the path of the transmission interface needs to be switched. In other words, the present invention can switch the path of the transmission interface without the need of performing a handover procedure firstly.

A fourth embodiment of the present invention will be described with reference to FIGS. 2, 1A, 1B and 1C. A network system 2 of the fourth embodiment comprises a wireless communication station 10, a source base station B1 and a target base station B2. The wireless communication station 10 comprises a first UE module 11, a second UE module 13 and a base station module 12 that is electrically connected with both the first UE module 11 and the second UE module 13. This embodiment will be described as follows.

Firstly, the wireless communication station 10 needs to perform a handover procedure in some cases. For example, the wireless communication station 10 needs to perform the handover procedure when the QoS of the base station that originally serves the wireless communication station 10 degrades or fails to reach a preset level, when the RSRP between the base station and the wireless communication station 10 decreases, or when the SINR between the base station and the wireless communication station 10 increases, and/or when the wireless communication station 10 moves into communication coverage of the target base station B2. When the wireless communication station 10 needs to be handed over, a handover procedure is performed between the first UE module 11, the source base station B1 and the target base station B2.

Before the handover procedure is performed, the first UE module 11 further has a first original transmission interface (not shown) with the source base station B1 via a first wireless connection C1. The first original transmission interface of this embodiment is the same as the original transmission interface described in the second embodiment and, thus, will not be further described herein.

When the handover procedure is performed on the first wireless connection C1, the base station module 12 may detach the first original transmission interface with the source base station B1, for example, through the transmission interface adjustment procedure P3. It should be appreciated that, the base station B″ described in the transmission interface adjustment procedure P3 is the source base station B1 in this embodiment; i.e., the procedures S20 and S21 are performed to notify the management entity MME″ and the neighbor base station NB that the first original transmission interface has been detached. However, it is not intended to limit the time point at which the first original transmission interface is detached, and the first original transmission interface may also be detached in other period rather than the period of performing the handover procedure.

Furthermore, the source base station B1 and the target base station B2 can communicate with each other to exchange via an X2 message therebetween information related to the first wireless connection C1. However, in other implementations, the source base station B1 and the target base station B2 can also exchange the information related to the first wireless connection in other ways.

After the handover procedure is completed, the first wireless connection C1 that is originally between the wireless communication station 10 and the source base station B1 is changed to be between the wireless communication station 10 and the target base station B2, i.e., becomes a first wireless connection C1′. If the wireless communication station 10 (e.g., the base station module 12) or the target base station B2 determines that the QoS of the base station that originally serves the wireless communication station 10 degrades or fails to reach a preset level, the RSRP between the base station and the wireless communication station 10 decreases, or the SINR between the base station and the wireless communication station 10 increases, the measurement data reported by the wireless communication station 10 to the target base station B2 indicates, then the transmission interface between the wireless communication station 10 and the source base station B1 and the target base station B2 is switched. If the wireless communication station 10 is a mobile station, the transmission interface between the wireless communication station 10 and the source base station B1 and the target base station B2 is switched after each handover procedure, or after the mobile station passes through a fixed number of base stations, or when the mobile station stops in some specific regions.

Next, when the wireless communication station 10 (e.g., the base station module 12) or the target base station B2 determines that the path of the transmission interface needs to be switched to shorten the transmission path, the switching operation is performed as follows. The base station module 12 has established a second original transmission interface (not shown) with the target base station B2 via the first wireless connection C1′, for example, through the transmission interface setup procedure P2. Here, the base station module BM and the base station B′ described in the transmission interface setup procedure P2 are respectively the base station module 12 and the target base station B2 in this embodiment. Usually, a serving gateway, a packet data network gateway and a relay gateway are anchored to an initial base station (not shown), so the second original transmission interface has four kinds of implementations as follows.

Two implementations of the second original transmission interface are cases where the original base station is the source base station B1. In this context, the second original transmission interface is between the base station module 12, the first UE module 11, a base station module of the target base station B2, and a serving gateway, a packet data network gateway and a relay gateway of the source base station B1. In such a case, the second original transmission interface is an S1 interface. Alternatively, the second original transmission interface is between the base station module 12, the first UE module 11, a base station module and a serving gateway of the target base station B2, and a packet data network gateway and a relay gateway of the source base station B1. In such a case, the second original transmission interface is defined to have an S5/S8 interface between the serving gateway of the target base station B2 and the packet data network gateway of the source base station B1, and have an S1 interface between the base station module 12, the first UE module 11, and the base station module and the serving gateway of the target base station B2.

The other two implementations are cases where the original base station and the source base station B1 are different base stations. In this context, the second original transmission interface is between the base station module 12, the first UE module 11, a base station module of the target base station B2, and a serving gateway, a packet data network gateway and a relay gateway of the original base station. In such a case, the second original transmission interface is an S1 interface. Alternatively, the second original transmission interface is between the base station module 12, the first UE module 11, a base station module and a serving gateway of the target base station B2, and a packet data network gateway and a relay gateway of the original base station. In such a case, the second original transmission interface is defined to have an S5/S8 interface between the serving gateway of the target base station B2 and the packet data network gateway of the original base station, and have an S1 interface between the base station module 12, the first UE module 11, and the base station module and the serving gateway of the target base station B2.

The second UE module 13 establishes a second wireless connection C2 with the target base station B2, for example, through the wireless connection setup procedure P1. Here, the UE module U and the base station B described in the wireless connection setup procedure P1 are respectively the second UE module 13 and the target base station B2 in this embodiment.

Afterwards, the base station module 12 establishes a target transmission interface (not shown) with the target base station B2 via the second wireless connection C2, for example, through the transmission interface setup procedure P2. Thereby, the target transmission interface is formed between the base station module 12, the second UE module 13, and a base station module, a serving gateway, a packet data network gateway and a relay gateway of the target base station B2 (not shown). Here, the base station module BM and the base station B′ described in the transmission interface setup procedure P2 are respectively the base station module 12 and the target base station B2 in this embodiment.

After the target transmission interface is established, the base station module 12 performs a transmission interface adjustment procedure on the second original transmission interface. In other words, the base station module 12 may detach the second original transmission interface with the target base station B2, for example, through the transmission interface adjustment procedure P3. However, in other implementations, the base station module 12 may detach the second original transmission interface with the target base station B2 not after the target transmission interface is established. It should be appreciated that, the base station B″ described in the transmission interface adjustment procedure P3 is the target base station B2 in this embodiment; i.e., the procedures S20 and S21 are performed to notify the management entity MME″ and the neighbor base station NB that the second original transmission interface has been detached.

Afterwards, the first UE module 11 disconnects the first wireless connection C1′ with the target base station B2. The aforesaid target transmission interface may be an S1/X2 interface.

It should be appreciated that, in this embodiment, it is not required to perform the handover procedure firstly before the wireless communication station 10 (e.g., the base station module 12) or the target base station B2 determines that the path of the transmission interface needs to be switched. In other words, the present invention can switch the path of the transmission interface without the need of performing a handover procedure firstly.

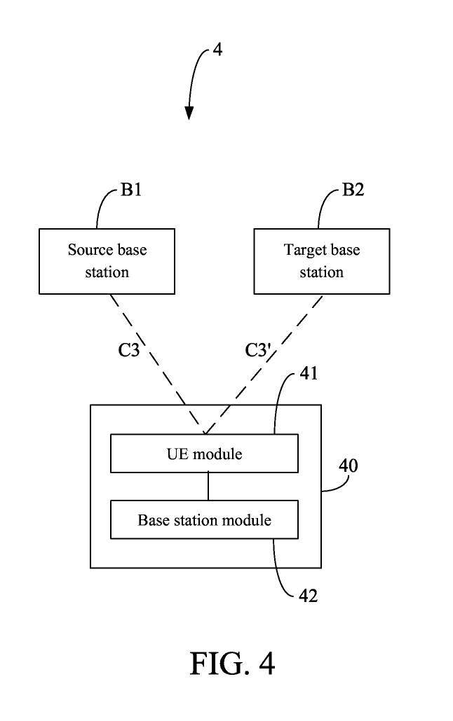

A fifth embodiment of the present invention will be described with reference to FIGS. 4, 1A, 1B and 1C. A network system 4 of the fifth embodiment comprises a wireless communication station 40, a source base station B1 and a target base station B2. The wireless communication station 40 comprises a UE module 41 and a base station module 42 which is electrically connected with the UE module 41. This embodiment will be detailed as follows.

Firstly, the wireless communication station 40 needs to perform a handover procedure in some cases. For example, the wireless communication station 40 needs to perform the handover procedure when the QoS of the base station that originally serves the wireless communication station 40 degrades or fails to reach a preset level, when the RSRP between the base station and the wireless communication station 40 decreases, or when the SINR between the base station and the wireless communication station 40 increases, and/or when the wireless communication station 40 moves into communication coverage of the target base station B2. When the wireless communication station needs to be handed over, a handover procedure is performed between the UE module 41, the source base station B1 and the target base station B2.

Before the handover procedure is performed, the UE module 41 further has a first original transmission interface (not shown) with the source base station B1 via a wireless connection C3. The first original transmission interface of this embodiment is the same as the original transmission interface described in the second embodiment and, thus, will not be further described herein.

When the handover procedure is performed on the wireless connection C3, the base station module 42 detaches the first original transmission interface with the source base station B1, for example, through the transmission interface adjustment procedure P3. However, in other embodiments, the base station module 42 may detach the first original transmission interface with the source base station B1 in other period rather than the period of performing the handover procedure. It should be appreciated that, the base station B″ described in the transmission interface adjustment procedure P3 is the source base station B1 in this embodiment; i.e., the procedures S20 and S21 are performed to notify the management entity MME″ and the neighbor base station NB that the original transmission interface has been detached.

Furthermore, the source base station B1 and the target base station B2 can communicate with each other to exchange via an X2 message therebetween information related to the wireless connection C3. However, in other implementations, the source base station B1 and the target base station B2 can also exchange the information related to the wireless connection in other ways.

After the handover procedure is completed, the wireless connection C3 that is originally between the wireless communication station 40 and the source base station B1 is changed to be between the wireless communication station 40 and the target base station B2, i.e., becomes a wireless connection C3′. In such a case, the base station module 42 establishes a second original transmission interface with the target base station B2 via the wireless connection C3′, for example, through the transmission interface setup procedure P2. Here, the base station module BM and the base station B′ described in the transmission interface setup procedure P2 are respectively the base station module 42 and the target base station B2 in this embodiment. Corresponding relationships between individual elements in the second original transmission interface of this embodiment are the same as those described in the fourth embodiment except that the UE module 41 of this embodiment corresponds to the first UE module 11 of the fourth embodiment, so no further description will be made herein.

Next, if the wireless communication station 40 (e.g., the base station module 42) or the target base station B2 determines that a preset condition for interface adjustment is satisfied, i.e., if the QoS of the base station that originally serves the wireless communication station 40 degrades or fails to reach a preset level, the RSRP between the base station and the wireless communication station 40 decreases, or the SINR between the base station and the wireless communication station 40 increases, or the measurement data reported by the wireless communication station 40 to the target base station B2 indicates, then the transmission interface between the wireless communication station 40 and the target base station B2 is adjusted. If the wireless communication station 40 is a mobile station, the transmission interface between the wireless communication station 40 and the target base station B2 is adjusted after each handover procedure, or after the mobile station passes through a fixed number of base stations, or when the mobile station stops in some specific regions.

Next, when the wireless communication station 40 (e.g., the base station module 42) or the target base station B2 determines that the path of the transmission interface needs to be switched, the wireless communication station 40 (e.g., the base station module 42) or the target base station B2 generates an interface adjustment request so that the second original transmission interface is adjusted into a target transmission interface (not shown), for example, through the transmission interface adjustment procedure P3 according to the interface adjustment request. Thereby, the target transmission interface is formed between the base station module 42, the UE module 41, and a base station module, a serving gateway, a packet data network gateway and a relay gateway of the target base station B2 (not shown). Here, the base station B″ described in the transmission interface adjustment procedure P3 is the target base station B2 in this embodiment.

The interface adjustment comprises the following operations. Firstly, the target base station B2 and a mobility management entity change the second original transmission interface so that the serving gateway of the target base station B2 instead of a serving gateway of an original base station is used in the second original transmission interface. Furthermore, the serving gateway and the packet data network gateway of the target base station B2, the mobility management entity, and the packet data network gateway of the original base station change the second original transmission interface so that the packet data network gateway of the target base station B2 instead of the packet data network gateway of the original base station is used in the transmission path.

The interface adjustment further comprises the following operation. The packet data network gateway of the original base station, the serving gateway of the target base station B2, the mobility management entity, the base station module (e.g., the base station module of the target base station B2 or the base station module 42) and the UE module 41 detach a path between the packet data network gateway of the original base station and the serving gateway of the target base station B2 in the second original transmission interface. After the aforesaid adjustment is completed, the task of adjusting the second original transmission interface into the target transmission interface is completed. As will be appreciated by those skilled in the art, the original base station may be just the source base station B1 or a base station other than the source base station B1, and this will not be further described herein.

It should be appreciated that, in this embodiment, it is not required to perform the handover procedure firstly before the wireless communication station 40 (the base station module 42) or the target base station B2 determines that the path of the transmission interface needs to be switched. In other words, the present invention can adjust the path of the transmission interface without the need of performing a handover procedure firstly.

It should be appreciated that, it is not required in this embodiment that the process in which the wireless communication station 40 (e.g., the base station module 42) or the target base station B2 generates an interface adjustment request when the wireless communication station 40 (e.g., the base station module 42) or the target base station B2 determines that the path of the transmission interface needs to be switched must be performed. In other words, this embodiment can adjust the second original transmission interface into a target transmission interface without the need of making the aforesaid determination firstly.

It should be appreciated that, in the first to the fifth embodiments, when switching is made between the original transmission interface, the first original transmission interface, the second original transmission interface and the target transmission interface, data related to the original transmission interface, the first original transmission interface, the second original transmission interface and the target transmission interface is exchanged between the packet data network gateway (of the original base station) and the serving gateway (of the original base station, the source base station B1 or the target base station B2), between the serving gateway (of the original base station, the source base station B1, or the target base station B2) and a mobility management entity, between the mobility management entity and the serving gateway of the target base station B2, and between the serving gateway of the target base station B2 and the packet data network gateway (of the original base station or the target base station B2).

The data is, for example, mapping information which is used to map the relay node bearer or the user equipment bearer, or is ip addresses of the serving gateway and the packet data network gateway before and after the switching, or the like data.

The base station module (i.e., any base station module of the present invention) and the mobility management entity exchange therebetween the data via an S1 interface message (e.g., an MME status transfer message, an MME configuration update message, a UE context modification request/response message) or a new S1 interface message.

The aforesaid data can also be exchanged between two base station modules (i.e., any two base station modules of the present invention) via an X2 interface message (e.g., an eNB configuration update message, an eNB configuration update acknowledge message) or a new X2 interface message. As will be appreciated by people skilled in the art, the original base station and the source base station B1 may be a same base station or different base stations.

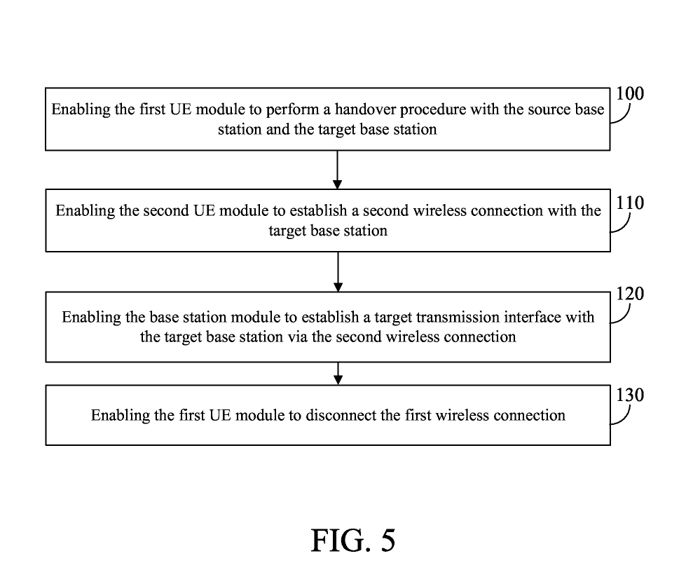

A sixth embodiment of the present invention is a transmission interface switching method, a flowchart diagram of which is depicted in the FIG. 5. The transmission interface switching method is for use in a wireless communication station of a network system. The network system comprises the wireless communication station, a source base station and a target base station. The wireless communication station comprises a first UE module, a second UE module and a base station module. The base station module is electrically connected with the second UE module, and the first UE module has a first wireless connection with the source base station.

Firstly, the transmission interface switching method executes step 100 to enable the first UE module to perform a handover procedure with the source base station and the target base station, so that the first wireless connection is between the first UE module and the target base station after the handover procedure.

When the wireless communication station (e.g., the base station module) or the target base station determines that the path of the transmission interface needs to be switched, the switching operation is performed as follows. Step 110 is executed to enable the second UE module to establish a second wireless connection with the target base station.

Afterwards, step 120 is executed to enable the base station module to establish a target transmission interface with the target base station via the second wireless connection so that the target transmission interface is formed between the base station module, the second UE module, and a base station module, a serving gateway, a packet data network gateway and a relay gateway of the target base station. In addition, step 130 is executed to enable the first UE module to disconnect the first wireless connection.

It should be appreciated that, in this embodiment, it is not required to perform the handover procedure firstly before the wireless communication station (e.g., the base station module) or the target base station determines that the path of the transmission interface needs to be switched. In other words, the present invention can execute steps 110, 120 and 130 directly without executing the step 100.

In addition to the aforesaid steps, the sixth embodiment can also execute all the operations set forth in the first embodiment. How the sixth embodiment executes these operations will be readily appreciated by those of ordinary skill in the art based on the explanation of the first embodiment and, thus, will not be further described herein.

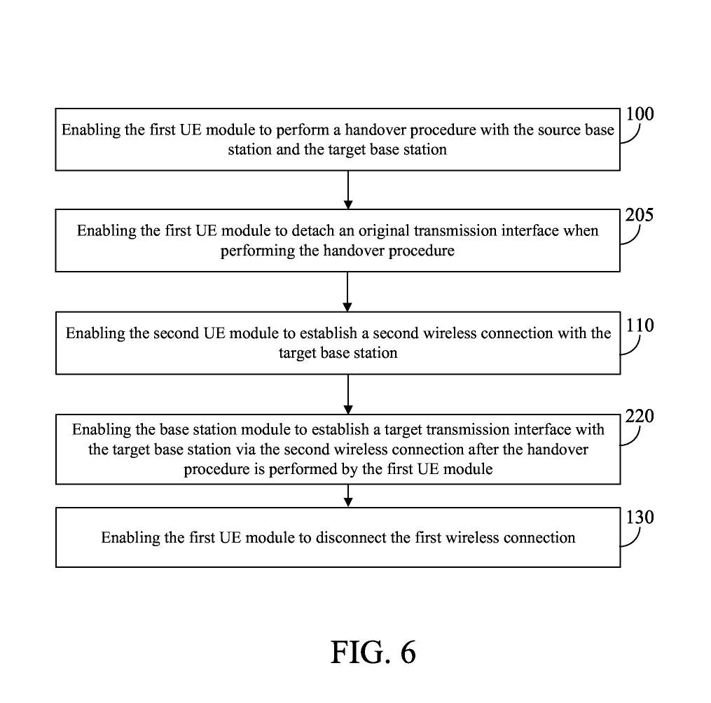

A seventh embodiment of the present invention is a transmission interface switching method, a flowchart diagram of which is depicted in FIG. 6. The transmission interface switching method is for use in a wireless communication station of a network system. The network system comprises the wireless communication station, a source base station and a target base station. The wireless communication station comprises a first UE module, a second UE module and a base station module. The base station module is electrically connected with both the first UE module and the second UE module, and the first UE module has a first wireless connection with the source base station. The base station module also has an original transmission interface with an original base station or the source base station that is established via the first wireless connection. For the original transmission interface, reference may be made to the description of the second embodiment, and no further description will be made herein. It should be appreciated that steps 100, 110 and 130 to be described later are the same as those described in the sixth embodiment.

Firstly, the transmission interface switching method executes step 100 to enable the first UE module to perform a handover procedure with the source base station and the target base station so that the first wireless connection is between the first UE module and the target base station after the handover procedure. Next, step 205 is executed to enable the first UE module to detach the original transmission interface when performing the handover procedure. Furthermore, the source base station and the target base station can communicate to each other to exchange therebetween information related to the first wireless connection via an X2 message. However, in other implementations, the source base station and the target base station can also exchange therebetween the information related to the first wireless connection in other ways.

If the wireless communication station (e.g., the base station module) or the target base station determines that the path of the transmission interface needs to be switched, the switching operation is performed as follows. Step 110 is executed to enable the second UE module to establish a second wireless connection with the target base station. Then, step 220 is executed to enable the base station module to establish a target transmission interface with the target base station via the second wireless connection after the handover procedure is performed by the first UE module, so that the target transmission interface is formed between the base station module, the second UE module, and a base station module, a serving gateway, a packet data network gateway and a relay gateway of the target base station. Next, step 130 is executed to enable the first UE module to disconnect the first wireless connection.

It should be appreciated that, the order of the steps 100 and 205 is not particularly limited in the present invention; and furthermore, the step 205 may also be comprised in the step 100.

It should be further appreciated that, in this embodiment, it is not required to perform the handover procedure firstly before the wireless communication station (e.g., the base station module) or the target base station determines that the path of the transmission interface needs to be switched. In other words, the present invention can execute the steps 205, 110, 220 and 130 directly without executing the step 100. Moreover, conditions to perform the handover procedure are not limited in the steps 205 and 220 either.

In addition to the aforesaid steps, the seventh embodiment can also execute all the operations set forth in the second embodiment. How the seventh embodiment executes these operations will be readily appreciated by those of ordinary skill in the art based on the explanation of the second embodiment and, thus, will not be further described herein.

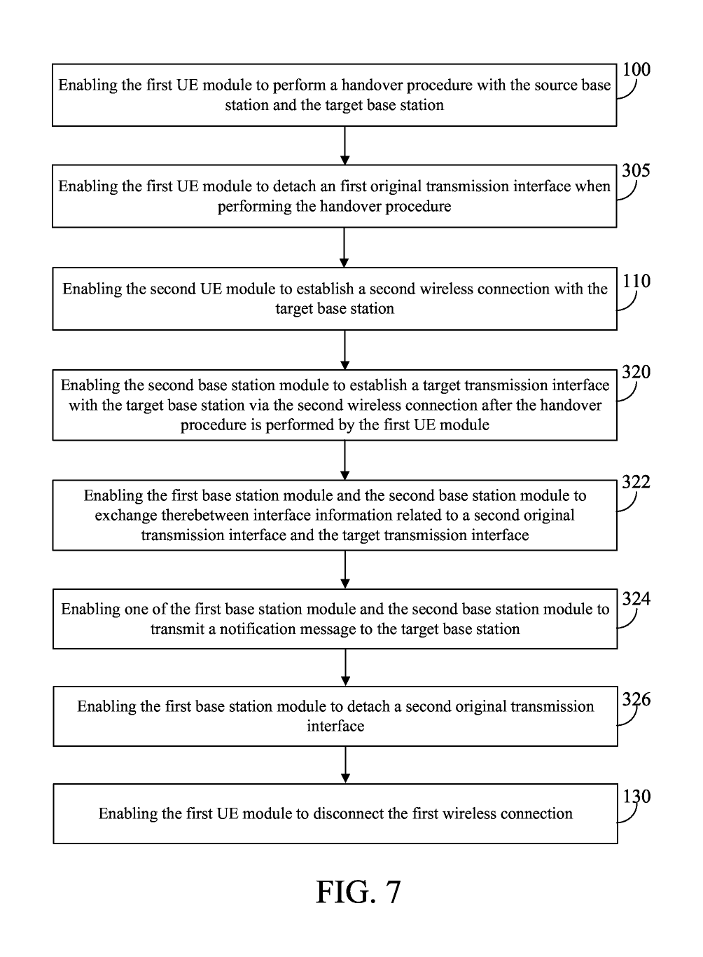

An eighth embodiment of the present invention is a transmission interface switching method, a flowchart diagram of which is depicted in FIG. 7. The transmission interface switching method is for use in a wireless communication station of a network system. The wireless communication station comprises a first UE module, a second UE module, a first base station module and a second base station module. The first UE module is electrically connected with the first base station module, and the second UE module is electrically connected with the second base station module. The first base station module also has a first original transmission interface with an original base station or the source base station that is established via the first wireless connection. For the first original transmission interface, reference may be made to the description of the first original transmission interface in the third embodiment, and no further description will be made herein. It should be appreciated that, steps 100, 110 and 130 to be described later are the same as those described in the sixth embodiment.

Firstly, the transmission interface switching method executes step 100 to enable the first UE module to perform a handover procedure with the source base station and the target base station so that the first wireless connection is between the first UE module and the target base station after the handover procedure. Next, step 305 is executed to enable the first UE module to detach the first original transmission interface when performing the handover procedure. Furthermore, the source base station and the target base station can communicate to each other to exchange therebetween information related to the first wireless connection via an X2 message. However, in other implementations, the source base station and the target base station can also exchange therebetween the information related to the first wireless connection in other ways.

After the handover procedure is completed, the first base station module establishes a second original transmission interface with the target base station via the first wireless connection. For the second original transmission interface, reference may be made to the description of the second original transmission interface in the third embodiment, and no further description will be made herein.

When the wireless communication station (e.g., the first base station module or the second base station module) or the target base station determines that the path of the transmission interface needs to be switched, the switching operation is performed as follows. Step 110 is executed to enable the second UE module to establish a second wireless connection with the target base station. Then, step 320 is executed to enable the second base station module to establish a target transmission interface with the target base station via the second wireless connection after the handover procedure is performed by the first UE module, so that the target transmission interface is formed between the second base station module, the second UE module, and a base station module, a serving gateway, a packet data network gateway and a relay gateway of the target base station.

While the target transmission interface is being established, the transmission interface switching method further executes step 322 to enable the first base station module and the second base station module to exchange interface information related to the second original transmission interface and the target transmission interface. The interface information may be exchanged via a current or new X2 message, or an internal communication protocol message between the first base station module and the second base station module. Subsequently, step 324 is executed to enable the first base station module or the second base station module to transmit a notification message to the target base station, so that the target base station performs a transmission interface adjustment procedure. The transmission interface adjustment procedure is just as described with respect to the transmission interface adjustment procedure P3 depicted in FIG. 1C. Here, the target base station updates interface information with the mobility management entity MME″ and the neighbor base station NB through the transmission interface adjustment procedure P3. Here, the base station B″ described in the transmission interface adjustment procedure P3 is the target base station in this embodiment.

After the step 320 is executed in the transmission interface switching method, step 326 is further executed to enable the first base station module to detach the second original transmission interface. Next, step 130 is executed to enable the first UE module to disconnect the first wireless connection.

It should be appreciated that, the order of the steps 100, 305 and 326 is not particularly limited in the present invention; and furthermore, the step 305 may also be comprised in the step 100.

It should be further appreciated that, in this embodiment, it is not required to perform the handover procedure firstly before the wireless communication station (e.g., the first base station module or the second base station module) or the target base station determines that the path of the transmission interface needs to be switched. In other words, the present invention can execute the steps 305, 110, 320, 322, 324, 326 and 130 directly without executing the step 100. Moreover, conditions to perform the handover procedure are not limited in the steps 305 and 320 either.

In addition to the aforesaid steps, the eighth embodiment can also execute all the operations set forth in the third embodiment. How the eighth embodiment executes these operations will be readily appreciated by those of ordinary skill in the art based on the explanation of the third embodiment and, thus, will not be further described herein.

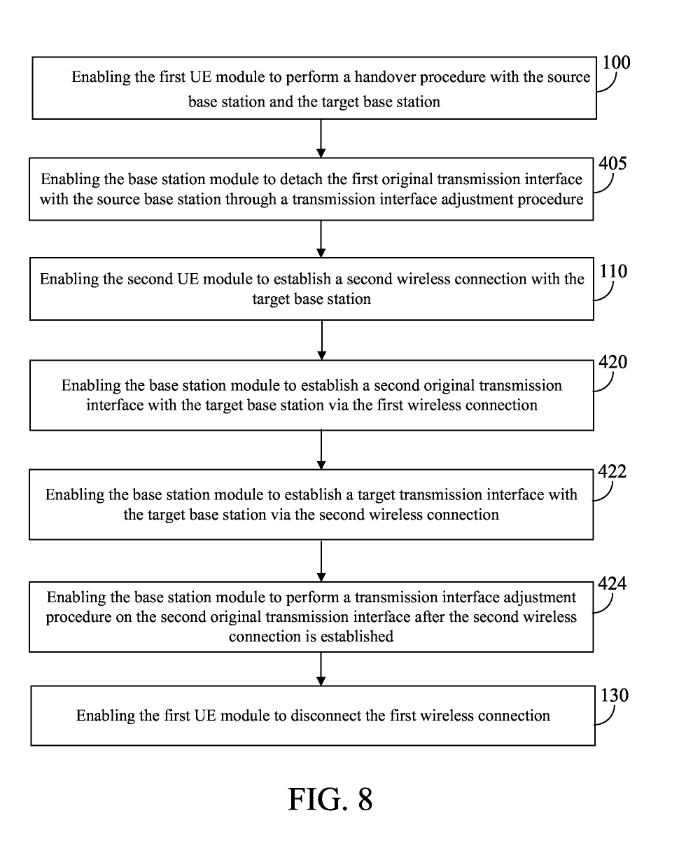

A ninth embodiment of the present invention is a transmission interface switching method, a flowchart diagram of which is depicted in FIG. 8. The transmission interface switching method is for use in a wireless communication station of a network system. The network system comprises the wireless communication station, a source base station and a target base station. The wireless communication station comprises a first UE module, a second UE module and a base station module. The base station module is electrically connected with both the first UE module and the second UE module, and the first UE module has a first wireless connection with the source base station. It should be appreciated that, steps 100, 110 and 130 to be described later are the same as those described in the sixth embodiment.

The base station module also has a first original transmission interface with an original base station or the source base station that is established via the first wireless connection. For the first original transmission interface, reference may be made to the description of the fourth embodiment, and no further description will be made herein.

Firstly, the transmission interface switching method executes step 100 to enable the first UE module to perform a handover procedure with the source base station and the target base station so that the first wireless connection is between the first UE module and the target base station after the handover procedure. Furthermore, the source base station and the target base station can communicate to each other to exchange therebetween information related to the first wireless connection via an X2 message. However, in other implementations, the source base station and the target base station can also exchange therebetween the information related to the first wireless connection in other ways.

When the handover procedure is performed on the first wireless connection, the transmission interface switching method further executes step 405 to enable the base station module to detach the first original transmission interface with the source base station through a transmission interface adjustment procedure. It should be appreciated that, the transmission interface adjustment procedure here may be the transmission interface adjustment procedure P3 depicted in FIG. 1C, and the base station B″ described in the transmission interface adjustment procedure P3 of FIG. 1C is the source base station in this embodiment; i.e., the procedures S20 and S21 are performed to notify the management entity MME″ and the neighbor base station NB that the first original transmission interface has been detached. However, it is not intended to limit the time point at which the first original transmission interface is detached, and the first original transmission interface may also be detached after the handover procedure.

When the wireless communication station (e.g., the base station module) or the target base station determines that the path of the transmission interface needs to be switched, the switching operation is performed as follows. Step 110 is executed to enable the second UE module to establish a second wireless connection with the target base station. Then, step 420 is executed to enable the base station module to establish a second original transmission interface with the target base station via the first wireless connection after the handover procedure. The second original transmission interface has four implementations, which have already been described in the fourth embodiment and, thus, will not be further described herein.

Next, step 422 is executed to enable the base station module to establish a target transmission interface with the target base station via the second wireless connection so that the target transmission interface is formed between the base station module, the second UE module, and a base station module, a serving gateway, a packet data network gateway and a relay gateway of the target base station.

Afterwards, step 424 is executed to enable the base station module to perform a transmission interface adjustment procedure on the second original transmission interface after the target transmission interface is established. However, the transmission interface adjustment procedure may be performed not after the second wireless connection or the target transmission interface is established. The transmission interface adjustment procedure may be the transmission interface adjustment procedure P3 depicted in FIG. 1C, and is configured to detach the second original transmission interface between the base station module and the target base station. It should be appreciated that, the base station B″ described in the transmission interface adjustment procedure P3 is the source base station in this embodiment; i.e., the procedures S20 and S21 are performed to notify the management entity MME″ and the neighbor base station NB that the second original transmission interface has been detached. Afterwards, step 130 is executed to enable the first UE module to disconnect the first wireless connection.

It should be appreciated that, the order of the steps 100, 405 and 420 is not particularly limited in the present invention; and furthermore, the step 405 may also be comprised in the step 100.

It should be further appreciated that, in this embodiment, it is not required to perform the handover procedure firstly before the wireless communication station (e.g., the base station module) or the target base station determines that the path of the transmission interface needs to be switched. In other words, the present invention can execute the steps 405, 110, 420, 422, 424 and 130 directly without executing the step 100. Moreover, conditions to perform the handover procedure are not limited in steps 405 and 420 either.

In addition to the aforesaid steps, the ninth embodiment can also execute all the operations set forth in the fourth embodiment. How the ninth embodiment executes these operations will be readily appreciated by those of ordinary skill in the art based on the explanation of the fourth embodiment and, thus, will not be further described herein.

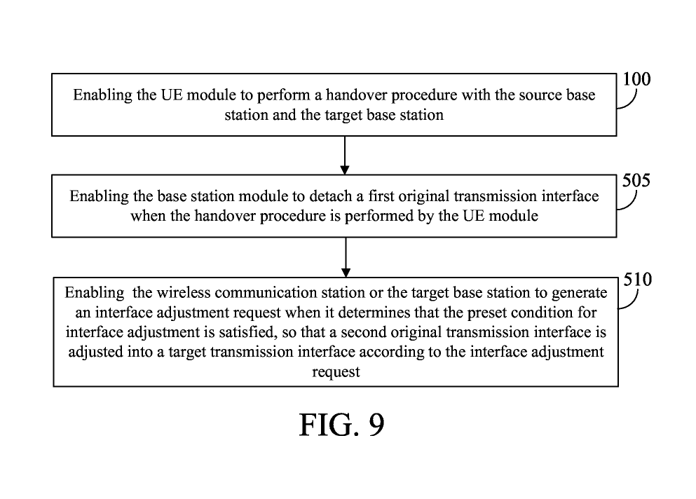

A tenth embodiment of the present invention is a transmission interface switching method, a flowchart diagram of which is depicted in FIG. 9. The transmission interface switching method is for use in a wireless communication station of a network system. The network system comprises the wireless communication station, a source base station and a target base station. The wireless communication station comprises a UE module and a base station module that is electrically connected with the UE module.

Before a handover procedure, the UE module further has a first original transmission interface with the source base station via the wireless connection. The implementation of the first original transmission interface of this embodiment has been described in the fifth embodiment and, thus, will not be described herein.

Firstly, the transmission interface switching method executes step 100 to enable the UE module to perform a handover procedure with the source base station and the target base station so that the wireless connection is between the UE module and the target base station after the handover procedure. Furthermore, the source base station and the target base station can communicate to each other to exchange therebetween information related to the wireless connection via an X2 message. However, in other implementations, the source base station and the target base station can also exchange therebetween the information related to the wireless connection in other ways.

When the wireless communication station (e.g., the base station module) or the target base station determines that the path of the transmission interface needs to be switched, the switching operation is performed as follows. When the handover procedure is performed on the wireless connection, the transmission interface switching method further executes step 505 to enable the base station module to detach the first original transmission interface with the source base station via a transmission interface adjustment procedure. It should be appreciated that, the transmission interface adjustment procedure here may be the transmission interface adjustment procedure P3 depicted in FIG. 1C, and the base station B″ described in the transmission interface adjustment procedure P3 of FIG. 1C is the source base station in this embodiment; i.e., the procedures S20 and S21 are performed to notify the management entity MME″ and the neighbor base station NB that the original transmission interface has been detached. However, this is not intended to limit the time point at which the original transmission interface is detached, and the original transmission interface may also be detached after the handover procedure.

After the handover procedure is performed by the UE module, the base station module establishes a second original transmission interface with the target base station via the wireless connection and through a transmission interface adjustment procedure. The transmission interface adjustment procedure may be, for example, the transmission interface adjustment procedure P3 depicted in FIG. 1C. Here, the base station module BM and the base station B′ described in the transmission interface adjustment procedure P3 are respectively the base station module and the target base station in this embodiment. The second original transmission interface of this embodiment is the same as the second original transmission interface described in the fourth embodiment and, thus, will not be further described herein.

If the wireless communication station (e.g., the base station module) or the target base station determines that a preset condition for interface adjustment is satisfied, i.e., if the QoS of the base station that originally serves the wireless communication station degrades or fails to reach a preset level, the RSRP between the base station and the wireless communication station decreases, or the SINR between the base station and the wireless communication station increases, or the measurement data reported by the wireless communication station to the target base station indicates, then the transmission interface between the wireless communication station and the target base station is adjusted. If the wireless communication station is a mobile station, the transmission interface between the wireless communication station and the target base station is adjusted after each handover procedure, or after the mobile station passes through a fixed number of base stations, or when the mobile station stops in some specific regions.

Next, when the wireless communication station (e.g., the base station module) or the target base station determines that the path of the transmission interface needs to be switched, step 510 is executed to enable the wireless communication station (e.g., the base station module) or the target base station to generate an interface adjustment request when it determines that the preset condition for interface adjustment is satisfied, so that the second original transmission interface is adjusted into a target transmission interface (not shown) according to the interface adjustment request.

The target transmission interface is formed between the base station module, the UE module, and a base station module, a serving gateway, a packet data network gateway and a relay gateway of the target base station. It should be appreciated that, it is not required in this embodiment that the process in which the wireless communication station (e.g., the base station module) or the target base station generates an interface adjustment request when the wireless communication station (e.g., the base station module) or the target base station determines that the path of the transmission interface needs to be switched must be performed. In other words, this embodiment can adjust the second original transmission interface into the target transmission interface without the need of making the aforesaid determination firstly.

The interface adjustment comprises the following operations. Firstly, the target base station and a mobility management entity adjust the second original transmission interface so that the serving gateway of the target base station instead of a serving gateway of an original base station is used in the second original transmission interface. Furthermore, the serving gateway and the packet data network gateway of the target base station, the mobility management entity and a packet data network gateway of the original base station adjust the second original transmission interface so that the packet data network gateway of the target base station instead of a packet data network gateway of the original base station .

The interface adjustment further comprises the following operation. The packet data network gateway of the original base station, the serving gateway of the target base station, the mobility management entity, the base station module (e.g., the base station module of the target base station or the base station module) and the UE module detach a path between the packet data network gateway of the original base station and the serving gateway of the target base station in the second original transmission interface. After the aforesaid adjustment is completed, the process of adjusting the second original transmission interface into the target transmission interface is completed. As will be appreciated by those skilled in the art, the original base station may be just the source base station or a base station other than the source base station, and no further description will be made herein.

It should be appreciated that, the order of the steps 100 and 505 is not particularly limited in the present invention; and furthermore, the step 505 may also be comprised in the step 100.

It should be further appreciated that, in this embodiment, it is not required to perform the handover procedure firstly before the base station module or the target base station determines that the path of the transmission interface needs to be switched. In other words, the present invention can execute the steps 505 and 510 directly without executing the step 100. Moreover, conditions to perform the handover procedure are not limited in the steps 505 and 510 either.

In addition to the aforesaid steps, the tenth embodiment can also execute all the operations set fifth in the second embodiment. How the tenth embodiment executes these operations will be readily appreciated by those of ordinary skill in the art based on the explanation of the fifth embodiment and, thus, will not be further described herein.

According to the above embodiments, the wireless communication station of the present invention switches the transmission interface appropriately after a handover procedure. Then, the transmission interface path used between the target base station and the wireless communication station becomes the shortest after the transmission interface is switched. Thereby, the wireless communication station and the transmission interface switching method of the present invention can avoid problems such as the transmission delay or the transmission quality degradation caused by a too long transmission interface.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication station for use in a network system, the network system comprising the wireless communication station and a base station, the wireless communication station comprising:
a first user equipment (UE) module, having a first wireless connection with the base station;
a second UE module, being configured to establish a second wireless connection with the base station; and
a first base station module electrically connected with the second UE module, being configured to establish a target transmission interface with the base station via the second wireless connection so that the target transmission interface is formed between the first base station module, the second UE module, and a base station module, a serving gateway, a packet data network gateway and a relay gateway of the base station;
wherein the first UE module is further configured to disconnect the first wireless connection.

2. The wireless communication station as claimed in claim 1, wherein the network system further comprises a source base station and the first UE module is further configured to perform a handover procedure with the source base station and the base station so that the first wireless connection is between the first UE module and the base station after the handover procedure.

3. The wireless communication station as claimed in claim 2, wherein the first UE module is electrically connected with the first base station module, the first base station module establishes the target transmission interface after the handover procedure is performed by the first UE module;
wherein the first base station module has an original transmission interface with an original base station that is established via the first wireless connection before the handover procedure is performed and the first base station module is configured to detach the original transmission interface when the handover procedure is performed by the first UE module.

4. The wireless communication station as claimed in claim 1, further comprising:
a second base station module, being electrically connected with the first UE module and having an original transmission interface with the base station and an original base station that is established via the first wireless connection and being configured to detach the original transmission interface after the target transmission interface is established.

5. The wireless communication station as claimed in claim 4, wherein the first base station module and the second base station module further exchange therebetween interface information related to the original transmission interface and the target transmission interface and one of the first base station module and the second base station module transmits a notification message to the base station so that the base station performs a transmission interface adjustment procedure.

6. A wireless communication station for use in a network system, the network system comprising the wireless communication station and a base station, the wireless communication station comprising:
a first UE module, having a first wireless connection with the base station; and
a base station module electrically connected with the first UE module;
a second UE module electrically connected with the base station module and being configured to establish a second wireless connection with the base station;
wherein the base station module is further configured to establish a first original transmission interface with the base station via the first wireless connection, perform a transmission interface adjustment procedure on the first original transmission interface, and establish a target transmission interface with the base station via the second wireless connection so that the target transmission interface is formed between the base station module, the second UE module, and a base station module, a serving gateway, a packet data network gateway and a relay gateway of the base station, and wherein the first UE module is further configured to disconnect the first wireless connection.

7. The wireless communication station as claimed in claim 6, wherein the network system further comprises a source base station and the first UE module is further configured to perform a handover procedure with the source base station and the base station so that the first wireless connection is between the first UE module and the base station after the handover procedure;
wherein the base station module has a second original transmission interface with an original base station that is established via the first wireless connection before the handover procedure is performed, and is configured to detach the second original transmission interface when the handover procedure is performed by the first UE module.

8. The wireless communication station as claimed in claim 6, wherein the base station module is further configured to perform the transmission interface adjustment procedure on the first original transmission interface after the target transmission interface is established.

9. A wireless communication station for use in a network system, the network system comprising the wireless communication station and a base station, the wireless communication station comprising:
a UE module, having a wireless connection with the base station; and
a base station module electrically connected with the UE module;
wherein a first original transmission interface between the base station module and the base station that is established via the wireless connection is adjusted into a target transmission interface so that the target transmission interface is formed between the base station module, the UE module, and a base station module, a serving gateway, a packet data network gateway and a relay gateway of the base station.

10. The wireless communication station as claimed in claim 9, wherein the network system further comprises a source base station and the UE module is further configured to perform a handover procedure with the source base station and the base station so that the wireless connection is between the UE module and the base station after the handover procedure;
wherein the base station module has a second original transmission interface with an original base station that is established via the wireless connection before the handover procedure is performed and the base station module is configured to detach the second original transmission interface when the handover procedure is performed by the UE module.

11. The wireless communication station as claimed in claim 9, wherein adjusting the first original transmission interface into the target transmission interface comprises changing from a serving gateway of an original base station to the serving gateway of the target base station, changing from a packet data network gateway of the original base station to the packet data network gateway of the target base station, and detaching a path in the first original transmission interface, wherein the path is between the packet data network gateway of the original base station and the serving gateway of the target base station.

12. A transmission interface switching method for use in a wireless communication station of a network system, the network system comprising the wireless communication station and a base station, the wireless communication station comprising a first UE module, a second UE module and a first base station module, the first base station module being electrically connected with the second UE module, and the first UE module having a first wireless connection with the base station, the transmission interface switching method comprising the steps of:
(a) enabling the second UE module to establish a second wireless connection with the base station;
(b) enabling the first base station module to establish a target transmission interface with the base station via the second wireless connection so that the target transmission interface is formed between the first base station module, the second UE module, and a base station module, a serving gateway, a packet data network gateway and a relay gateway of the base station; and
(c) enabling the first UE module to disconnect the first wireless connection.

13. The transmission interface switching method as claimed in claim 12, wherein the network system further comprises a source base station, and the transmission interface switching method further comprises the following step before the step (a):
(d) enabling the first UE module to perform a handover procedure with the source base station and the base station so that the first wireless connection is between the first UE module and the base station after the handover procedure.

14. The transmission interface switching method as claimed in claim 13, wherein the first UE module is electrically connected with the first base station module, the first base station module establishes the target transmission interface after the handover procedure is performed by the first UE module, and the first base station module has an original transmission interface with an original base station that is established via the first wireless connection before the handover procedure is performed, the transmission interface switching method further comprises the step of:
(e) enabling the first base station module to detach the original transmission interface when the handover procedure is performed by the first UE module.

15. The transmission interface switching method as claimed in claim 12, wherein the wireless communication station further comprises a second base station module, the second base station module is electrically connected with the first UE module and has an original transmission interface with the base station and an original base station via the first wireless connection, and the transmission interface switching method further comprises the step:
(e) enabling the second base station module to detach the original transmission interface after the target transmission interface is established.

16. The transmission interface switching method as claimed in claim 15, further comprising the steps of:
(f) enabling the first base station module and the second base station module to exchange therebetween interface information related to the original transmission interface and the target transmission interface; and
(g) enabling one of the first base station module and the second base station module to transmit a notification message to the base station so that the base station performs a transmission interface adjustment procedure.

17. A transmission interface switching method for use in a wireless communication station of a network system, the network system comprising the wireless communication station and a base station, the wireless communication station comprising a first UE module, a second UE module and a base station module, both the first UE module and the second UE module being electrically connected with the base station module, and the first UE module having a first wireless connection with the base station, the transmission interface switching method comprising the steps of:
(a) enabling the second UE module to establish a second wireless connection with the base station;
(b) enabling the base station module to establish a first original transmission interface with the base station via the first wireless connection;
(c) enabling the base station module to perform a transmission interface adjustment procedure on the first original transmission interface;
(d) enabling the base station module to establish a target transmission interface with the base station via the second wireless connection so that the target transmission interface is formed between the base station module, the second UE module, and a base station module, a serving gateway, a packet data network gateway and a relay gateway of the base station; and
(e) enabling the first UE module to disconnect the first wireless connection.

18. The transmission interface switching method as claimed in claim 17, wherein the network system further comprises a source base station, and the transmission interface switching method further comprises the following step before the step (a):
(f) enabling the first UE module to perform a handover procedure with the source base station and the base station so that the first wireless connection is between the first UE module and the base station after the handover procedure;
wherein the base station module has a second original transmission interface with an original base station that is established via the first wireless connection before the handover procedure is performed, and the transmission interface switching method further comprises the following step of:
(g) enabling the base station module to further detach the second original transmission interface when the handover procedure is performed by the first UE module.

19. The transmission interface switching method as claimed in claim 17, further comprising the step of:
enabling the base station module to perform the transmission interface adjustment procedure on the first original transmission interface after the target transmission interface is established.

20. A transmission interface switching method for use in a wireless communication station of a network system, the network system comprising the wireless communication station and a base station, the wireless communication station comprising a UE module and a base station module electrically connected with the UE module, and the UE module having a wireless connection with the base station, the transmission interface switching method comprising the step of:
(a) adjusting a first original transmission interface between the base station module and the base station that is established via the wireless connection into a target transmission interface via the wireless connection so that the target transmission interface is formed between the base station module, the UE module, and a base station module, a serving gateway, a packet data network gateway and a relay gateway of the base station.

21. The transmission interface switching method as claimed in claim 20, wherein the network system further comprises a source base station, and the transmission interface switching method further comprises the following step before the step (a):
(b) enabling the UE module to perform a handover procedure with the source base station and the base station so that the wireless connection is between the UE module and the base station after the handover procedure;
wherein the base station module has a second original transmission interface with an original base station that is established via the wireless connection before the handover procedure is performed, and the transmission interface switching method further comprises the following step after the step (a):
enabling the base station module to detach the second original transmission interface when the handover procedure is performed by the UE module.

22. The transmission interface switching method as claimed in claim 20, wherein adjusting the first original transmission interface into the target transmission interface comprises changing from a serving gateway of an original base station to the serving gateway of the target base station, changing from a packet data network gateway of the original base station to the packet data network gateway of the target base station, and disconnecting a path in the first original transmission interface, wherein the path is between the packet data network gateway of the original base station and the serving gateway of the target base station.
